(19) United States
(12) Patent Application Publication
(10) Pub. No.: US 2025/0216343 A1
(43) Pub. Date: Jul. 3, 2025

(54) METHOD AND DEVICE OF INSPECTING SURFACE OF INTERCONNECT STRUCTURE

(71) Applicant: CHENG MEI INSTRUMENT TECHNOLOGY CO., LTD., HSINCHU COUNTY (TW)

(72) Inventors: CHIH-YUAN LIN, HSINCHU COUNTY (TW); YU-WEI LIU, HSINCHU COUNTY (TW); FENG-JUI SHIH, HSINCHU COUNTY (TW); HSIN-YI YEH, HSINCHU COUNTY (TW); HUNG-CHUN LO, HSINCHU COUNTY (TW); CHAO-YU HUANG, HSINCHU COUNTY (TW); CHUN-PIN HSU, HSINCHU COUNTY (TW); CHENG-TAO TSAI, HSINCHU COUNTY (TW)

(21) Appl. No.: 18/608,363

(22) Filed: Mar. 18, 2024

(30) Foreign Application Priority Data
Dec. 27, 2023 (TW) 112151178

(51) Int. Cl. G01N 21/956; G01N 21/64; G01N 21/88

(52) U.S. Cl. CPC G01N 21/95684; G01N 21/6456; G01N 21/8806; G01N 2021/6478

(57) ABSTRACT

A method and device of inspecting a surface of an interconnect structure are provided. The interconnect structure includes a metal layer and a dielectric layer having fluorescence characteristics. The method includes: generating an excitation light beam from an excitation light source; adjusting the excitation light beam to cause the excitation light beam to form an elongated light spot having a long axis and a short axis on a surface of the interconnect structure, and cause the excitation light beams for forming the elongated light spot to be incident on the surface of the interconnect structure along a direction perpendicular to the long axis of the elongated light spot; receiving a plurality of fluorescent signals generated from the dielectric layer upon excitation thereof by the elongated light spot; and determining a portion of a planar pattern of the metal layer according to the fluorescence signals.

### CROSS-REFERENCE TO RELATED APPLICATIONS

This application claims priority of Taiwan application No. 112151178, filed on Dec. 27, 2023, which is incorporated by reference in its entirety.

### BACKGROUND OF THE PRESENT DISCLOSURE

### Field of the Present Disclosure

The present disclosure relates to a method of inspecting an interconnect structure, and more particularly to a method of inspecting an interconnect structure having fluorescence content.

### Description of the Prior Art

A redistribution layer (RDL) is included in an integrated circuit (IC) and comprises wirings for interconnecting components/conductors at different positions in the integrated circuit. For instance, in wafer-level packaging (WLP), a redistribution layer is usually included in an integrated circuit to connect input/output ends narrowly distributed across the integrated circuit to solder pads or solder balls widely distributed on packaged dies. In general, a redistribution layer comprises metal layers located on multiple planes, and each metal layer comprises multiple metal wirings spaced apart from each other by dielectric layers.

Superficial metal of a redistribution layer has to be inspected during the manufacturing process to detect short circuits, open circuits or deformations so as to ensure the quality of the redistribution layer. To facilitate the inspection, prior art teaches introducing fluorescent substances into dielectric layers and detecting, during the inspection process, fluorescence signals generated from the dielectric layers to evaluate the distribution of the dielectric layers and thereby determine the distribution of metal layers. However, when it comes to fluorescent light emitted from the dielectric layers excited with excitation light, the uppermost metal layer of the redistribution layer is likely to block the excitation light which will otherwise be incident on the dielectric layers; as a result, the intensity of fluorescence signals generated by part of the dielectric layers weakens, and thus the distribution of the dielectric layers or metal layers is incorrectly determined. Therefore, it is imperative to effectively inspect the distribution of superficial metal.

### SUMMARY OF THE PRESENT DISCLOSURE

An embodiment of the present disclosure provides a method of inspecting a surface of an interconnect structure. The interconnect structure comprises a metal layer and a dielectric layer having fluorescence characteristics. The method of inspecting a surface of an interconnect structure comprises steps of: generating an excitation light beam from an excitation light source; adjusting the excitation light beam to cause the excitation light beam to form an elongated light spot having a long axis and a short axis on a surface of the interconnect structure, and cause the excitation light beam for forming the elongated light spot to be incident on the surface of the interconnect structure along a direction perpendicular to the long axis of the elongated light spot; receiving a plurality of fluorescent signals generated from the dielectric layer upon excitation thereof by the elongated light spot; and determining a portion of a planar pattern of the metal layer according to the fluorescence signals.

Another embodiment of the present disclosure provides a device of inspecting a surface of an interconnect structure. The interconnect structure comprises a metal layer and a dielectric layer having fluorescence characteristics. The device of inspecting a surface of an interconnect structure comprises an excitation light source, a light shape adjustment module, a sensor and a controller. The excitation light source generates an excitation light beam. The light shape adjustment module adjusts the excitation light beams to cause the excitation light beams to form an elongated light spot having a long axis and a short axis on a surface of the interconnect structure, and cause the excitation light beam for forming the elongated light spot to be incident on the surface of the interconnect structure along a direction perpendicular to the long axis of the elongated light spot. The sensor receives a plurality of fluorescent signals generated from the dielectric layer upon excitation thereof by the elongated light spot. The controller determines a portion of a planar pattern of the metal layer according to the fluorescence signals.

### BRIEF DESCRIPTION OF THE DRAWINGS

FIG. 1 is a top view of a portion of an interconnect structure according to an embodiment of the present disclosure.

FIG. 2 is a cross-sectional view of a superficial structure of the interconnect structure of FIG. 1.

FIG. 3 is a schematic view of how to illuminate the interconnect structure of FIG. 1 with excitation light beams.

FIG. 4 is an imaging schematic view created by receiving fluorescence signals generated from a dielectric layer in the illumination situation of FIG. 3.

FIG. 5 is a schematic view of the process flow of a method of inspecting the surface of an object according to an embodiment of the present disclosure.

FIG. 6 is a schematic view of how to inspect the interconnect structure of FIG. 1 with the method of FIG. 5.

FIG. 7 is a schematic view of how to illuminate the interconnect structure of FIG. 1 with excitation light beams according to the method of FIG. 5.

FIG. 8 is an imaging schematic view created by receiving fluorescence signals generated from a dielectric layer in the illumination situation of FIG. 7.

FIG. 9 is another schematic view of how to illuminate the interconnect structure of FIG. 1 with excitation light beams according to the method of FIG. 5.

FIG. 10 is a schematic view of the angle of incidence of the excitation light beams forming the elongated light spot of FIG. 9.

FIG. 11 is another schematic view of how to illuminate the interconnect structure of FIG. 1 with excitation light beams according to the method of FIG. 5.

FIG. 12 is a schematic view of the angle of incidence of the excitation light beams forming the elongated light spot of FIG. 11.

FIG. 13 is a schematic view of a device of inspecting a surface of an interconnect structure according to an embodiment of the present disclosure.

FIG. 14 and FIG. 15 are schematic views of adjusting light shape with a first lens and an objective lens according to an embodiment of the present disclosure.

FIG. 16 and FIG. 17 are schematic views of adjusting light shape with another first lens and another objective lens according to another embodiment of the present disclosure.

### DETAILED DESCRIPTION OF THE EMBODIMENTS

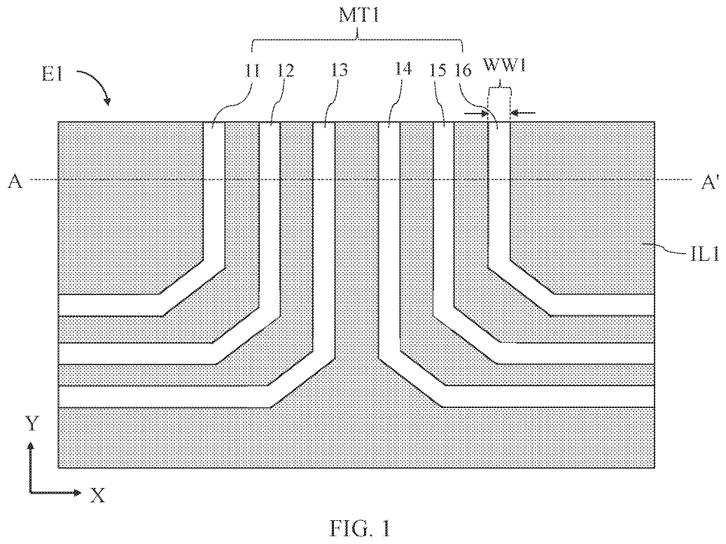

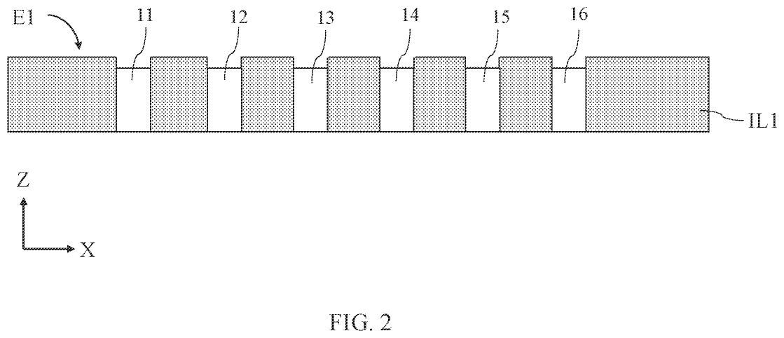

FIG. 1 is a top view of a portion of an interconnect structure E1 according to an embodiment of the present disclosure. FIG. 2 is a cross-sectional view of a superficial structure of the interconnect structure E1 taken along line A-A′. The interconnect structure E1 of the present disclosure includes, but not limited to, a printed circuit board, a semiconductor substrate or carrier, an interposer, a semiconductor chip or a redistribution layer (RDL) for use in packaging, or any other structure that provides lamination wirings. As shown in FIG. 1 and FIG. 2, the superficial structure of the interconnect structure E1 comprises a metal layer MT1 and a dielectric layer IL1. The metal layer MT1 comprises multiple wirings, such as wirings 11, 12, 13, 14, 15 and 16. The dielectric layer IL1 encloses the metal layer MT1 and spaces apart the wirings 11, 12, 13, 14, 15 and 16 of the metal layer MT1 from each other. In some embodiments, other circuit structures, such as multiple metal layers disposed on different planes and multiple dielectric layers adapted to space apart different metal layers from each other (not shown in FIG. 2), can be disposed below the superficial structure of the interconnect structure E1.

In the present embodiment, the dielectric layer IL1 may have fluorescence characteristics so as to facilitate the inspection of a planar pattern of the metal layer MT1 on the surface of the interconnect structure E1. In such case, the surface of the interconnect structure E1 is illuminated with excitation light beams to excite fluorescence substances in the dielectric layer IL1 so as for the fluorescence substances to emit fluorescent light. Then, fluorescence signals can be sensed to determine the distribution of the dielectric layer IL1 so as to determine the planar pattern of the metal layer MT1.

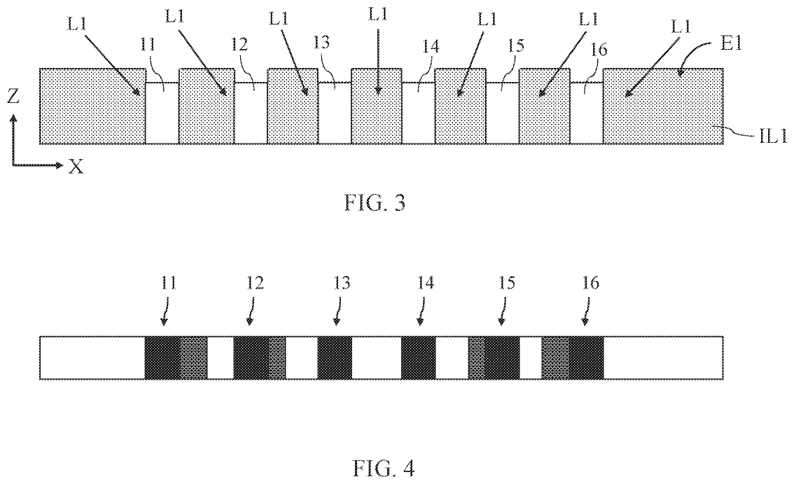

FIG. 3 is a schematic view of how to illuminate the interconnect structure E1 with excitation light beams. FIG. 4 is an imaging schematic view created by receiving fluorescence signals generated from the dielectric layers IL1 in the illumination situation of FIG. 3. In FIG. 3, excitation lights L1 illuminate the surface of the interconnect structure E1 with a rather large range, and the excitation lights L1 converge toward the surface of the interconnect structure E1 on XZ plane. Thus, as shown in FIG. 3, the excitation lights L1 incident on the left side (i.e., the side with decreasing X-axis component) of the wiring 13 come from the left side, and the excitation lights L1 incident on the right side (i.e., the side with increasing X-axis component) of the wiring 14 come from the right side. In such case, since the excitation lights L1 are blocked on their paths by the wirings 11, 12, 13, 14, 15 and 16 before being incident on the dielectric layer IL1, the dielectric layer IL1 does not receive light uniformly. For instance, a part of the dielectric layer IL1 located on the right side of the wiring 11 and the right side of the wiring 12 would receive the faint excitation lights L1 since the wirings 11 and 12 may block some of the excitation lights L1; also, a part of the dielectric layer IL1 located on the left side of the wiring 15 and the left side of the wiring 16 would receive the faint excitation light L1 since the wirings 15 and 16 may block some of the excitation lights L1.

As shown in FIG. 4, when illuminated with the excitation lights L1, since the wirings 11, 12, 13, 14, 15 and 16 do not have fluorescence characteristics, the wirings 11, 12, 13, 14, 15 and 16 do not emit fluorescent light, and thus, are schematically depicted as black blocks. Comparatively, parts of the dielectric layer IL1 that are located between the wirings 11, 12, 13, 14, 15 and 16 may receive a sufficient amount of the excitation lights L1 and generate fluorescence signals of a certain degree of intensity, and thus, such parts of the dielectric layer IL1 are schematically depicted as white blocks. Due to the distinguishable difference in the intensity of the received fluorescence signals between the white blocks and the black blocks, it can be certainly determined that the black blocks correspond in position to the metal layer MT1 and that the white blocks correspond in position to the dielectric layer IL1.

However, the other parts of the dielectric layer IL1 that are located on the right sides of the wirings 11 and 12 and the left sides of the wirings 15 and 16 may not receive sufficient excitation from the excitation lights L1 and may only emit faint fluorescent light; therefore, the other parts of the dielectric layer IL1 are schematically depicted as shaded blocks. In such case, due to the small difference in the intensity of the received fluorescence signals between the shaded blocks and the black blocks, it is difficult to determine whether the shaded blocks correspond in position to the metal layer MT1 or the dielectric layer IL1 but easy to make misjudgment.

In the present embodiment, the surface of the metal layer MT1 is lower than the surface of the dielectric layer IL1, but the present disclosure is not limited thereto. In some embodiments, the surface of the metal layer MT1 can be higher than the surface of the dielectric layer IL1, or the surface of the metal layer MT1 can be flush with the surface of the dielectric layer IL1. In such cases, the metal layer MT1 may block the dielectric layer IL1 to a greater extent.

In addition, owing to process advancement, the line width of the metal layer MT1 is ever-decreasing, which further increases the chance of misjudgment. As shown in FIG. 1, some of the wirings 11, 12, 13, 14, 15 and 16 of the metal layer MT1 extend in direction Y and have line width WW1 less than or equal to 20 μm in direction X (as shown in FIG. 1), or line width WW1/line spacing is less than or equal to 20 μm/20 μm (line spacing not shown). In the usage situation shown in FIG. 3, the excitation light is likely to be severely hidden by the sidewalls of the wirings 11, 12, 13, 14, 15 and 16, and in consequence the fluorescence intensity difference between the dielectric layer IL1 and the metal layer MT1 at the junction would be undistinguishable, rendering it difficult to accurately determine the wiring border of the metal layer MT1, resulting in border blurriness. The aforesaid metal sidewall concealment is especially severe when a metal layer of a small line width is inspected with a large field-of-view scan system.

In some embodiments, the angle at which the excitation light beam is incident on the interconnect structure E1 is adjusted to mitigate the blockage of the excitation light by the wirings 11, 12, 13, 14, 15 and 16, and thus the dielectric layer IL1 between the wirings 11, 12, 13, 14, 15 and 16 may uniformly receive the excitation light to reduce misjudgment.

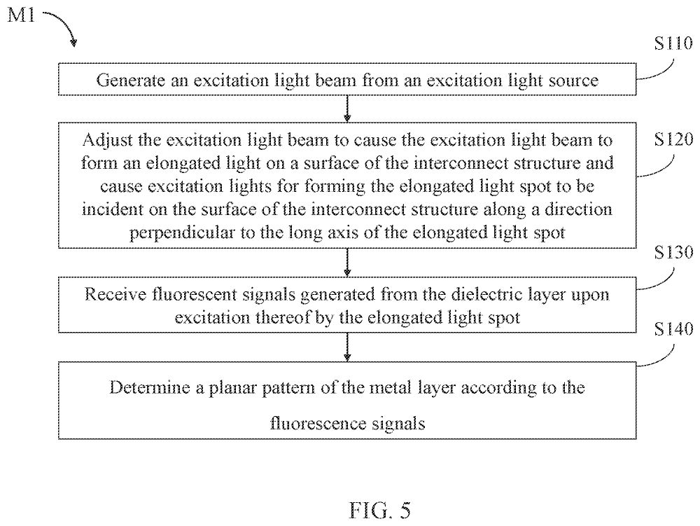

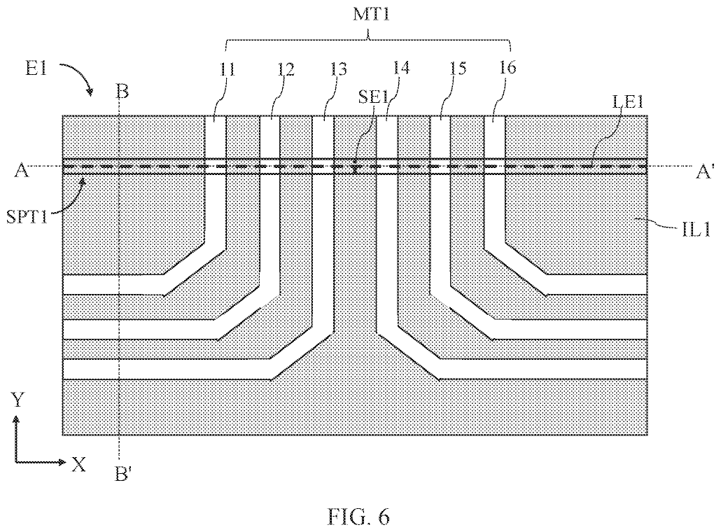

FIG. 5 is a schematic view of the process flow of a method M1 of inspecting the surface of an object according to an embodiment of the present disclosure. The method M1 comprises steps S110˜S140 and is applicable to inspecting the surface of the interconnect structure E1. FIG. 6 is a schematic view of how to inspect the interconnect structure E1 with the method M1.

In step S110, the excitation light source generates an excitation light beam. In step S120, the excitation light beam is adjusted to cause the excitation light beam to form an elongated light spot SPT1 having a long axis and a short axis on the surface of the interconnect structure E1, as shown in FIG. 6. In such case, the surface of the interconnect structure E1 receives the excitation light within the elongated light spot SPT1.

In some embodiments, a long axis LE1 of the elongated light spot SPT1 refers to, for example, but not limited thereto, an axis in the elongated light spot SPT1 that has the longest distance along a primary extension direction of the elongated light spot SPT1; on the other hand, a short axis SE1 of the elongated light spot SPT1 refers to, for example, but not limited thereto, an axis in the elongated light spot SPT1 that has the longest distance along a secondary extension direction of the elongated light spot SPT1. As shown in FIG. 6, the long axis LE1 of the elongated light spot SPT1 extends in a first direction (for example, direction X), and the short axis SE1 of the elongated light spot SPT1 extends in a second direction (for example, direction Y). In the present embodiment, the elongated light spot SPT1 is, for example, in the shape of a slender rectangle; the length of the long axis LE1 is equivalent to the length of the long side of the rectangle, and the length of the short axis SE1 is equivalent to the length of the short side of the rectangle, with the first direction being perpendicular to the second direction. However, the present disclosure is not limited thereto. In some embodiments, the elongated light spot SPT1 has, but is not limited to, a polygonal shape or an elliptical shape and may have at least one of the features as follows: having round corners, having non-flat long sides and/or short sides, having concave long sides and/or short sides, and having convex long sides and/or short sides. Furthermore, in a variant embodiment, the long axis LE1 of the elongated light spot SPT1 and the short axis SE1 of the elongated light spot SPT1 are not perpendicular to each other.

In some embodiments, the length of the long axis LE1 of the elongated light spot SPT1 is at least five times, for example, 10 times, greater than the length of the short axis SE1 of the elongated light spot SPT1 to facilitate a large field-of-view scan, thereby reducing the number of required scans and shortening the inspection duration. For instance, the length of the long axis LE1 of the elongated light spot SPT1 is, for example, but is not limited to, at least 3 mm, and the length of the short axis SE1 of the elongated light spot SPT1 is, for example, but is not limited to, 100 μm to 300 μm; however, the present disclosure is not limited thereto.

The surface of the interconnect structure E1 is illuminated with the elongated light spot SPT1 extensively in the extension direction (i.e., the first direction or direction X in the present embodiment) of the long axis LE1 thereof, and thus the wirings 11, 12, 13, 14, 15 and 16 arranged in the first direction and the dielectric layer disposed between the wirings 11, 12, 13, 14, 15 and 16 are illuminated with the elongated light spot SPT1. In such case, the step S120 of adjusting the light shape of the excitation light beam further comprises causing that the excitation lights forming the elongated light spot SPT1 to be incident on the surface of the interconnect structure E1 along a direction perpendicular to the long axis LE1 of the elongated light spot SPT1.

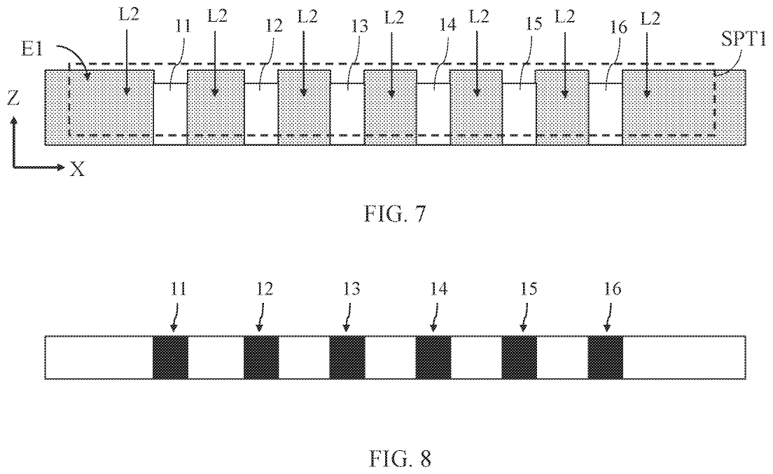

FIG. 7 is a schematic view of how to illuminate the interconnect structure E1 with the excitation lights L2 according to the method M1. FIG. 8 is an imaging schematic view created by receiving fluorescence signals generated from the dielectric layer IL1 in the illumination situation of FIG. 7. In the present embodiment, FIG. 7 is a cross-sectional view of the interconnect structure E1 taken along line A-A′ of FIG. 6.

As shown in FIG. 7, the excitation lights L2 for forming the elongated light spot SPT1 can be incident on the surface of the interconnect structure E1 along a direction perpendicular to the long axis LE1 of the elongated light spot SPT1; thus, the extent to which the excitation lights L2 are blocked on their paths by the wirings 11, 12, 13, 14, 15 and 16 is lessened so that the dielectric layer ILL disposed between the wirings 11, 12, 13, 14, 15 and 16 can uniformly receive the excitation light. In such case, as shown in FIG. 8, the dielectric layer IL1 disposed between the wirings 11, 12, 13, 14, 15 and 16 may receive the excitation light uniformly and thus generates fluorescence signals of adequate intensity. Therefore, in step S130, the fluorescence signals generated from the dielectric layer IL1 upon excitation thereof by the elongated light spot SPT1 can be received. In step S140, a corresponding portion of a planar pattern of the metal layer MT1 can be determined according to the received fluorescence signals.

In some embodiments, in step S130, a line scanner may be adopted to receive the fluorescence signals generated from the dielectric layer IL1 upon excitation thereof by the elongated light spot SPT1. Furthermore, the interconnect structure E1 may be placed on a track or a movable machine tool whereby the interconnect structure E1 moves gradually in an extension direction of the short axis (i.e., the second direction or direction Y) of the elongated light spot SPT1. Therefore, the elongated light spot SPT1 is conducive to scanning a complete surface of the interconnect structure E1 gradually so as to determine the complete planar pattern of the metal layer MT1 of the interconnect structure E1. In some embodiments, the interconnect structure E1 is illuminated in step S120 in the situation where the long axis LE1 of the elongated light spot SPT1 is parallel to or perpendicular to some of the wirings of the metal layer MT1, but the present disclosure is not limited thereto.

Furthermore, since the surface of the interconnect structure E1 is illuminated by the elongated light spot SPT1 with a rather small range along the extension direction of the short axis SE1 (i.e., the second direction or direction Y in the present embodiment) of the elongated light spot SPT1, fewer objects can be illuminated by the elongated light spot SPT1 along the short axis SE1 thereof, rendering it less likely for light to be blocked by the wirings. In this situation, in step S120, the step of adjusting the light shape of the excitation light beam may further includes converging the excitation lights L2 that form the elongated light spot SPT1 onto a plane of incidence including the short axis SE1 such that the excitation lights can propagate to the surface of the interconnect structure E1 with an angle. Therefore, the intensity of the excitation lights for illuminating the interconnect structure E1 within the range of the elongated light spot SPT1 can increase.

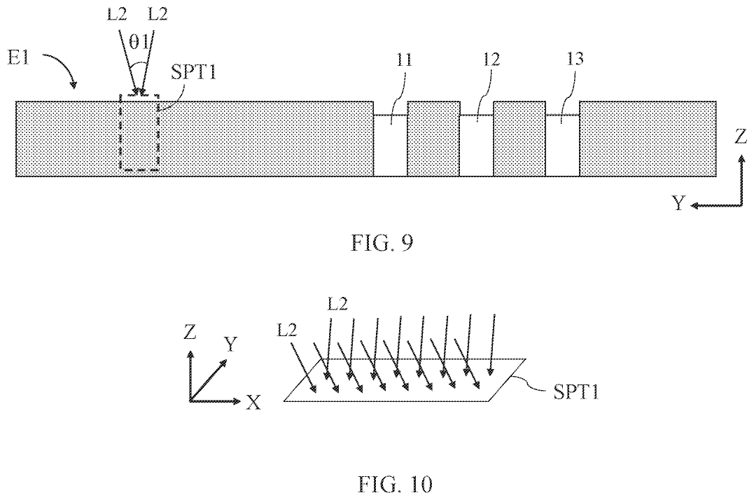

FIG. 9 is another schematic view of how to illuminate the interconnect structure E1 with excitation lights according to the method M1. FIG. 10 is a schematic view of the angle of incidence of the excitation lights L2 forming the elongated light spot SPT1 of FIG. 9. In the present embodiment, FIG. 9 is a cross-sectional view of the interconnect structure E1 taken along line B-B′ of FIG. 6. As shown in FIG. 9 and FIG. 10, the direction of propagation of the excitation lights L2 that form the elongated light spot SPT1 is perpendicular to the extension direction (i.e., the first direction or direction X) of the long axis LE1 and converges onto the plane of incidence including the short axis SE1; in other words, an angle θ1 can be defined between the propagation directions of the excitation lights toward the surface of the interconnect structure E1. In such case, the excitation lights L2 can gather more energy in a more localized area such that the dielectric layer IL1 illuminated with the elongated light spot SPT1 can be more effectively excited by the excitation lights L2 to emit fluorescent light.

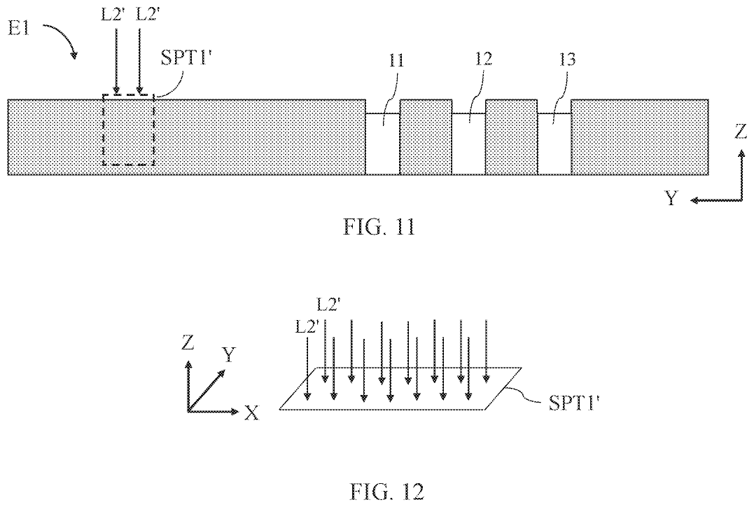

However, the present disclosure does not limit that the excitation lights forming the elongated light spot SPT1 should converge onto the plane of incidence comprising the short axis SE1. In some embodiments, in step S120, the excitation lights forming the elongated light spot SPT1 can be perpendicular to the extension direction of the short axis SE1. FIG. 11 is another schematic view of how to illuminate the interconnect structure E1 with excitation lights according to the method M1. As shown in FIG. 11, in step S120, excitation light beam is adjusted into an elongated light spot SPT1′, and the excitation lights L2′ forming the elongated light spot SPT1′ are adjusted to be perpendicular to the extension direction of the short axis SE1.

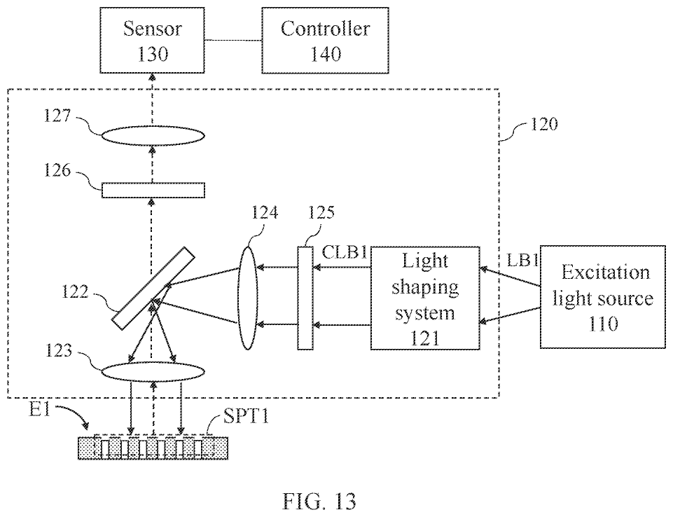

FIG. 11 is a cross-sectional view of the interconnect structure E1 taken along line B-B′ of FIG. 6, showing the illumination situation of the excitation lights L2′. FIG. 12 is a schematic view of the angle of incidence of the excitation lights L2′ forming the elongated light spot SPT1′ of FIG. 11. As shown in FIG. 11 and FIG. 12, the excitation lights L2′ forming the elongated light spot SPT1′ are perpendicular to the extension directions of both the long axis LE1 and the short axis SE1. Thus, the excitation lights L2′ forming the elongated light spot SPT1′ are collimated to illuminate the surface of the interconnect structure E1. In such case, the collimated excitation lights forming the elongated light spot SPT1′ can be incident on the dielectric layer IL1without being blocked by the wirings of the metal layer MT1 regardless of whether the wirings of the metal layer MT1 are arranged along the first direction or the second direction.

Since the method M1 of the present disclosure is effective in adjusting the excitation light beam to form the elongated light spot SPT1 (or SPT1′) for illuminating the interconnect structure E1 and allowing the excitation lights L2 (or L2′) for forming the elongated light spot SPT1 (or SPT1′) to be incident on the surface of the interconnect structure E1 along a direction perpendicular to the long axis LE1 of the elongated light spot SPT1 (or SPT1′), the issue that the excitation lights are blocked by the metal layer when the surface of the interconnect structure E1 is illuminated with the elongated light spot SPT1 (or SPT1′) having a larger field-of-view along the extension direction of the long axis LE1 can be relieved, thereby allowing the dielectric layer IL1 to receive the excitation light beams uniformly and increasing the range of the planar pattern of the metal layer MT1 that can be effectively determined in each inspection.

FIG. 13 is a schematic view of a device 100 of inspecting a surface of an interconnect structure according to an embodiment of the present disclosure. The device 100 includes an excitation light source 110, a light shape adjustment module 120, a sensor 130 and a controller 140. In some embodiments, the device 100 can execute the steps of the method M1 to determine a planar pattern of the metal layer MT1.

For instance, the excitation light source 110 can execute step S110 to generate excitation light beams LB1, and the light shape adjustment module 120 can execute step S120 to adjust the light path and light shape of the excitation light beams LB1 to not only cause the excitation light beams LB1 to form the elongated light spot SPT1 on the surface of the interconnect structure E1 but also cause the excitation lights for forming the elongated light spot SPT1 to be incident on the surface of the interconnect structure E1 along a direction perpendicular to the long axis LE1 of the elongated light spot SPT1. Then, the sensor 130 can execute step S130 to receive fluorescence signals generated from the dielectric layer IL1 upon excitation thereof. In some embodiments, the sensor 130 is, for example, a line scanner capable of time delay integration (TDI). Furthermore, in some embodiments, the sensor 130 can be a back-illuminated, high-photosensitivity sensor or an area scanner. The sensor 130 may include light-sensing elements, such as charge-coupled devices (CCDs) or CMOS active pixel sensors. In some embodiments, the sensor 130 may transform the intensity of fluorescence signals into electrical signals, and the controller 140 in step S140 can determine a corresponding portion of a planar pattern of the metal layer MT1 according to the electrical signals indicative of the intensity of fluorescence signals.

As shown in FIG. 13, the light shape adjustment module 120 includes a light shaping system 121, a beamsplitter 122, an objective lens 123, a first lens 124, a first filter 125, a second filter 126 and a second lens 127. In some embodiments, the light shaping system 121 shapes the excitation light beam LB1 into collimated light beams CLB1 (for example, but not limited to having a divergence angle of 10° or less), and the first lens 124 is disposed on the downstream light path of the light shaping system 121 to further adjust the light path of the collimated light beams CLB1. The beamsplitter 122 reflects the excitation light beams that have passed through the first lens 124. The objective lens 123 is disposed on the downstream light path of the first lens 124 to shape the excitation light beams reflecting off the beamsplitter 122 into the elongated light spot SPT1 on the interconnect structure E1. Thus, the focal length of the first lens 124 and the focal length of the objective lens 123 are appropriately selected so as to allow the collimated light beams CLB1 to be further shaped into the elongated light spot SPT1. In the present embodiment, an angle defined between the surface of the beamsplitter 122 and the optical axis of the first lens 124 can be 45°, and the optical axis of the first lens 124 can be perpendicular to the optical axis of the objective lens 123.

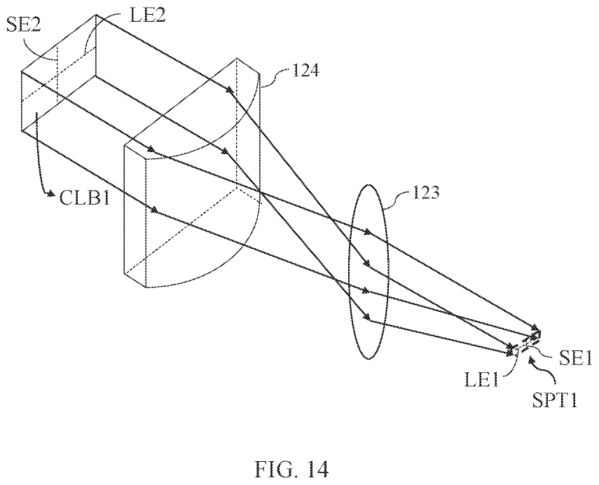

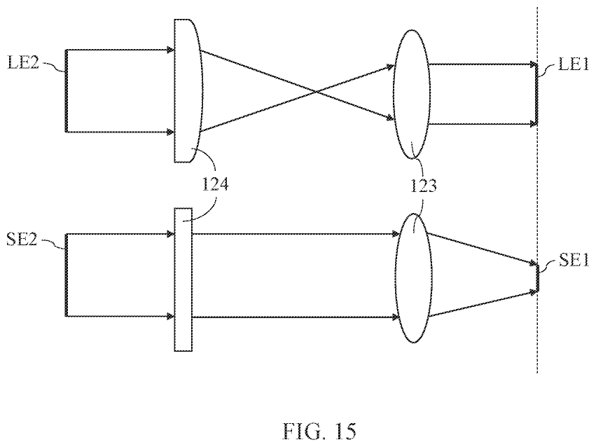

FIG. 14 and FIG. 15 are schematic views of adjusting light shape with the first lens 124 and the objective lens 123 according to an embodiment of the present disclosure, however, the adjustment of light paths by the beamsplitter 122 is omitted for brevity. As shown in FIG. 14, the first lens 124 is, for example, a semicylinder lens, and the objective lens 123 further converges the excitation lights that have passed through the first lens 124 into the elongated light spot SPT1.

In some embodiments, the cross section of the collimated light beam CLB1 has a long axis LE2 and a short axis SE2. For instance, in the embodiment illustrated by FIG. 14 and FIG. 15, the collimated light beam CLB1 has a rectangular cross section having the long axis LE2 of a length equivalent to the length of the long sides of the rectangle and having the short axis SE2 of a length equivalent to the length of the short sides of the rectangle. However, the present disclosure does not limit the cross section of the collimated light beam CLB1 should be rectangular. In some embodiments, the cross section of the collimated light beam CLB1 can be, for example, but not limited to, a polygonal shape or an elliptical shape, and may have at least one of the features as follows: having round corners, having non-flat long sides and/or short sides, having concave long sides and/or short sides, and having convex long sides and/or short sides.

Furthermore, the length of the long axis LE1 of the elongated light spot SPT1 can equal the product of the length of the long axis LE2 of the cross section of the collimated light beam CLB1, the reciprocal of the focal length F1 of the first lens 124, and the focal length F2 of the objective lens 123, as expressed in equation (1).

$$LE 1 = LE 2 \times \frac{F 2}{F 1} \qquad equation ( 1 )$$

In some embodiments, the length of the short axis SE1 of the elongated light spot SPT1 may relate to the length of the short axis SE2 of the cross section of the collimated light beam CLB1 and the focal length F2 of the objective lens 123, for example, as expressed in equation (2).

$$SE 1 = 4 {M}^{2} \times λ \times \frac{F 2}{π} \times SE 2 \qquad equation ( 2 )$$

In equation (2), M2 denotes the light beam quality factor (related to the light beam divergence angle) of the collimated light beam CLB1, and A denotes the wavelength of excitation light beams.

In the embodiment illustrated by FIG. 14 and FIG. 15, after being adjusted by the light shape adjustment module 120, the excitation lights L2 forming the elongated light spot SPT1 can converge onto the plane of incidence including the short axis SE1 of the elongated light spot SPT1, allowing the excitation lights forming the elongated light spot SPT1 can propagate to the surface of the interconnect structure E1 with an angle (as shown in FIG. 9 and FIG. 10); however, the present disclosure is not limited thereto. In some embodiments, the light shape adjustment module 120 may also have the excitation lights forming the elongated light spot perpendicular to the short axis SE1 of the elongated light spot SPT1.

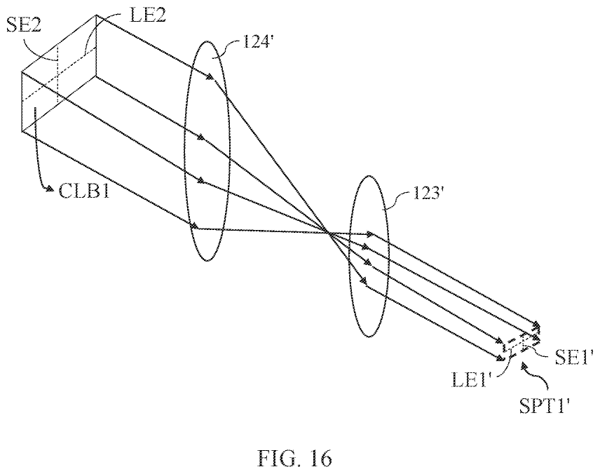

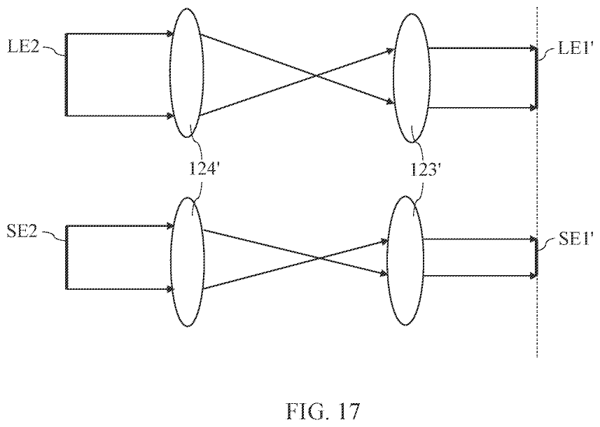

FIG. 16 and FIG. 17 schematically depict adjusting light shape with a first lens 124′ and an objective lens 123′ according to another embodiment of the present disclosure, however, the adjustment of a light path by the beamsplitter 122 is omitted for brevity. In some embodiments, the first lens 124′ is applicable to the light shape adjustment module 120 to replace the first lens 124, and the objective lens 123′ is applicable to the light shape adjustment module 120 to replace the objective lens 123. As shown in FIG. 16, both the first lens 124′ and the objective lens 123′ can be convex lenses, for example, plano-convex lenses, biconvex lenses, or any other lenses capable of converging rays of light. The first lens 124′ and the objective lens 123′ can adjust the collimated light beam CLB1 outputted from the light shaping system 121 into the elongated light spot SPT1′ having a long axis LE1′ and a short axis SE1′, and have the direction of the propagation of the excitation lights forming the elongated light spot SPT1′ perpendicular to both the extension direction of the long axis LE1′ of the elongated light spot SPT1′ and the extension direction of the short axis SE1′ of the elongated light spot SPT1′ (as shown in FIG. 11 and FIG. 12). In the present embodiment, the length of the long axis LE1′ of the elongated light spot SPT1′ may equal the product of the length of the long axis LE2 of the cross section of the collimated light beam CLB1, the reciprocal of the focal length F1′ of the first lens 124′, and the focal length F2′ of the objective lens 123′, as expressed by equation (3). Similarly, the length of the short axis SE1′ of the elongated light spot SPT1′ may equal the product of the length of the short axis SE2 of the cross section of the collimated light beam CLB1, the reciprocal of the focal length F1′ of the first lens 124′, and the focal length F2′ of the objective lens 123′, as expressed by equation (4).

$$LE {1}^{′} = LE 2 \times \frac{F 2 ′}{F 1 ′} \qquad equation ( 3 )$$

$$SE {1}^{′} = SE 2 \times \frac{F {2}^{′}}{F 1 ′} \qquad equation ( 4 )$$

When illuminated with the elongated light spot SPT1 (or SPT1′), the dielectric layer IL1 undergoes excitation to generate fluorescence signals. In some embodiments, the fluorescence signals generated from the dielectric layer IL1 are guided by the objective lens 123 to enter the beamsplitter 122. In some embodiments, the beamsplitter 122 is, for example, a dichroic lens or a pellicle mirror. In such case, the beamsplitter 122 can selectively allow fluorescence signals FL1 of long wavelengths to pass through while reflecting the excitation lights L2 of short wavelengths so as to separate the output light path of the excitation light beams from the input light path of the fluorescence signals.

Furthermore, the light shape adjustment module 120 further has the first filter 125 and the second filter 126. The first filter 125 is disposed on the output light path of the excitation light beams, for example, disposed between the light shaping system 121 and the first lens 124, allowing the excitation lights having wavelengths within a specific range to pass through. The second filter 126 is disposed on the input light path of the fluorescence signals to allow the fluorescence signals which have passed through the beamsplitter 122 to pass through. In some embodiments, the light shape adjustment module 120 allows users to change the second filter 126. That is, when inspecting different objects, since the different objects (for example, dielectric layers of different interconnect structures) may emit fluorescent lights of different wavelengths, a corresponding filter can be selected as the second filter 126 according to the range of wavelength of the fluorescent lights emitted by the object to be inspected. For instance, where a first object under inspection emits fluorescent light of a wavelength of 600 nm˜700 nm, a filter penetrable by lights of a wavelength of 600 nm˜700 nm can be placed on a lens holder (not shown) for the light shape adjustment module 120 so as to function as the second filter 126. Similarly, where a second object under inspection emits fluorescent light of a wavelength of 500 nm˜600 nm, the aforesaid filter can be replaced with another filter penetrable by lights of a wavelength of 500 nm˜600 nm such that the other filter is placed on a lens holder (not shown) for the light shape adjustment module 120 so as to function as the second filter 126. Furthermore, depending on the fluorescence characteristics of an object under inspection, the first filter 125 can be replaced (and so as the excitation light source 110) to adopt to another band of the excitation lights so as to optimize the efficiency of dielectric layer excitation. For instance, excitation lights of a wavelength of 500 nm˜550 nm may pass through the first filter 125 when a first object under inspection emits fluorescent light wavelength of 600 nm˜700 nm, and excitation lights of a wavelength of 400 nm˜450 nm may pass through the first filter 125 when a second object under inspection emits fluorescent light wavelength of 500 nm˜600 nm.

In some embodiments, the light shape adjustment module 120 further includes a second lens 127. The second lens 127 is disposed on the input light path of fluorescence signals, for example, disposed between the second filter 126 and the sensor 130, allowing the optical axis of the second lens 127 to coincide with the optical axis of the objective lens 123. The fluorescence signals FL1 which have passed through the second filter 126 are guided by the second lens 127 to the sensor 130. Therefore, the sensor 130 senses fluorescence signals generated from the dielectric layer IL1 and transforms the fluorescence signals into electrical signals for the controller 140 to determine the blocks corresponding in position to the metal layer MT1 and the dielectric layer IL1 respectively and thus determine the planar pattern of the metal layer MT1.

In conclusion, the method and device of inspecting a surface of an interconnect structure, as provided by the embodiments of the present disclosure, are effective in adjusting the excitation light beam to form the elongated light spot for illuminating the interconnect structure and allowing the excitation lights for forming the elongated light spot to be incident on the surface of the interconnect structure along a direction perpendicular to the long axis of the elongated light spot; therefore, the issue that the excitation lights are blocked by the metal layer when the surface of the interconnect structure is illuminated with the elongated light spot having a larger field-of-view along the extension direction of the long axis can be relieved, thereby allowing the dielectric layer to receive the excitation light beams uniformly and increasing the range of the planar pattern of the metal layer that can be effectively determined in each inspection.

What is claimed is:

1. A method of inspecting a surface of an interconnect structure, the method comprising steps of:
generating an excitation light beam from an excitation light source;
adjusting the excitation light beam to cause the excitation light beam to form an elongated light spot having a long axis and a short axis on a surface of the interconnect structure and cause excitation lights for forming the elongated light spot to be incident on the surface of the interconnect structure along a direction perpendicular to the long axis of the elongated light spot, wherein the interconnect structure comprises a metal layer and a dielectric layer having fluorescence characteristics;
receiving a plurality of fluorescent signals generated from the dielectric layer upon excitation thereof by the elongated light spot; and
determining a portion of a planar pattern of the metal layer according to the fluorescence signals.

2. The method of claim 1, wherein the step of adjusting the excitation light beam to allow the excitation light beam to form the elongated light spot having the long axis and the short axis on the surface of the interconnect structure comprises causing the excitation lights for forming the elongated light spot to be perpendicular to an extension direction of the short axis.

3. The method of claim 1, wherein the step of adjusting the excitation light beam to allow the excitation light beam to form the elongated light spot having the long axis and the short axis on the surface of the interconnect structure comprises causing propagation directions of the excitation lights for forming the elongated light spot toward the surface of the interconnect structure to form an angle on a plane of incidence including the short axis.

4. The method of claim 1, wherein the long axis is perpendicular to the short axis.

5. The method of claim 1, wherein a length of the long axis of the elongated light spot is at least five times a length of the short axis of the elongated light spot.

6. The method of claim 1, wherein the metal layer comprises a wiring having a line width less than or equal to 20 μm.

7. The method of claim 1, wherein the step of receiving the plurality of fluorescent signals generated from the dielectric layer upon excitation thereof by the elongated light spot comprises receiving the fluorescence signals with a line scanner.

8. The method of claim 1, further comprising a step of scanning a complete surface of the interconnect structure with the elongated light spot along an extension direction of the short axis to determine a complete planar pattern of the metal layer.

9. A device of inspecting a surface of an interconnect structure, the device comprising:
an excitation light source for generating an excitation light beam;
a light shape adjustment module for adjusting the excitation light beam to cause the excitation light beam to form an elongated light spot having a long axis and a short axis on a surface of the interconnect structure, and cause excitation lights for forming the elongated light spot to be incident on the surface of the interconnect structure along a direction perpendicular to the long axis of the elongated light spot, wherein the interconnect structure comprises a metal layer and a dielectric layer having fluorescence characteristics;
a sensor for receiving a plurality of fluorescent signals generated from the dielectric layer upon excitation thereof by the elongated light spot; and
a controller for determining a portion of a planar pattern of the metal layer according to the fluorescence signals.

10. The device of claim 9, wherein the light shape adjustment module causes the excitation lights for forming the elongated light spot to be perpendicular to an extension direction of the short axis.

11. The device of claim 9, wherein the light shape adjustment module causes propagation directions of the excitation lights for forming the elongated light spot toward the surface of the interconnect structure to form an angle on a plane of incidence including the short axis.

12. The device of claim 9, wherein a length of the long axis of the elongated light spot is at least five times a length of the short axis of the elongated light spot.

13. The device of claim 9, wherein the metal layer comprises a wiring having a line width less than or equal to 20 μm.

14. The device of claim 9, wherein the sensor comprises a line scanner.

15. The device of claim 9, wherein the light shape adjustment module comprises a light shaping system for shaping the excitation light beam into a collimated light beam, and the collimated light beam has a rectangular cross section.

16. The device of claim 15, wherein the light shape adjustment module further comprises:
a first lens disposed on a downstream light path of the light shaping system; and
an objective lens disposed on a downstream light path of the first lens,
wherein the first lens and the objective lens further shape the collimated light beam into the elongated light spot for being incident on the surface of the interconnect structure.

17. The device of claim 16, wherein the light shape adjustment module further comprises a first filter disposed between the light shaping system and the first lens, and penetrable by excitation lights with a wavelength falling within a specific range.

18. The device of claim 16, wherein the first lens is capable of converging light rays.

19. The device of claim 16, further comprising a second filter disposed between the interconnect structure and the sensor, and penetrable by the fluorescence signals generated from the dielectric layer upon excitation thereof by the elongated light spot.

20. The device of claim 16, wherein a length of the long axis of the elongated light spot equals a product of a length of a long axis of the cross section of the collimated light beam, a reciprocal of a focal length of the first lens, and a focal length of the objective lens.
